(19) United States
(12) Patent Application Publication
(10) Pub. No.: US 2024/0242117 A1
(43) Pub. Date: Jul. 18, 2024

(54) METHOD TO GENERATE TASKS FOR META-LEARNING

(71) Applicant: SAMSUNG ELETRÔNICA DA AMAZÔNIA LTDA., CAMPINAS (BR)

(72) Inventors: MICHEL CONRADO CARDOSO MENESES, CAMPINAS (BR); GABRIELA DANTAS ROCHA, CAMPINAS (BR); RAFAEL BERGAMO BARRETO DE HOLANDA, CAMPINAS (BR); DOUGLAS DAVID BAPTISTA DE SOUZA, CAMPINAS (BR)

(73) Assignee: SAMSUNG ELETRÔNICA DA AMAZÔNIA LTDA., CAMPINAS (BR)

(21) Appl. No.: 18/225,198

(22) Filed: Jul. 24, 2023

(30) Foreign Application Priority Data
Jan. 18, 2023 (BR) 10 2023 000929 8

(51) Int. Cl. G06N 20/00

(52) U.S. Cl. CPC G06N 20/00

(57) ABSTRACT

A method for generating meta-learning tasks in order to solve few-shot learning classification. The method enables the homogenization of the difficulty level of each task, so the meta-learning process better converges, and the resulting meta-model better generalizes. For each task, the method controls the distances of the data instances within a given class in the input feature domain based on a reference distribution obtained from a known dataset.

### CROSS-REFERENCE TO RELATED APPLICATION (S)

This application is based on and claims priority under 35 U.S.C. § 119 to Brazilian Patent Application No. BR 10 2023 000929 8, filed on Jan. 18, 2023, in the Brazilian Intellectual Property Office, the disclosure of which is incorporated by reference herein in its entirety.

### TECHNICAL FIELD

The present invention relates to an offline method to generate tasks for meta-learning. The technical field of this invention is deep learning for small datasets, with special focus on methods for creating dataset.

Few-shot learning is the sub-discipline of machine learning focused on inducing predictive models from small datasets. Whereas meta-learning is a subfield of machine learning concerned with the development of algorithms that automatically learn about their own learning processes (i.e., learn how to learn).

Meta-learning is usually applied on few-shot learning problems due to its capability of inducing a model that can be quickly adapted to solve a particular task based on little data. The term task refers to a self-contained and independent machine learning problem, composed of a training dataset and another one for testing, along with an evaluation function. When applied to the few-shot learning problem, meta-learning algorithms iteratively present a set of training tasks to a model so it can learn how to quickly adapt to a new task never seen before.

More specifically, the present invention is concerned with the generation of datasets for training models capable of solving few-shot learning classification tasks. Therefore, the objective of the present invention is to homogenize the difficulty level of each task so the meta-learning process can better converge, and the resulting meta-model can properly generalize. For each task, the distances between data instances of a given class in the input data domain are controlled based on a reference distribution obtained from a known dataset.

The reference distance distribution is modelled using nonparametric estimators prior to the meta-training process. One of the applications of this invention is to the problem of recognizing customizable keywords in a speech recognition system.

Although the current invention is being proposed as solution to a problem in the field of speech recognition, the methodology therein can be extended to other applications in which dataset creation is required to build tasks for few-shot learning systems, such as automatic face recognition and audio event detection.

### BACKGROUND

Wake-up systems are technologies responsible for activating voice-controlled devices, such as activating intelligent assistants, smart smartphones, or any subsystem of interest in a smart device. The activation criterion is often the detection of a particular snippet of audio captured by the device microphone. These audio snippets are usually specific voice commands or spoken keywords. Thus, the wake-up modules are commonly referred to as keyword spotters, and the task of detecting the spoken keywords is named keyword spotting (KWS). Most KWS modules are built for detecting specific, pre-determined keywords. A possible improvement upon existing KWS systems is developing a customizable keyword spotter, in which arbitrary commands can be chosen by the user as wake-up words. The automatic recognition of speech for custom wake-up words in edge devices should demand little data for training the model, as well as the inference task should be executed with no notable delay

The problem of few-shot learning consists on designing an AI system from few samples. Among the methods to solve the few-shot learning, there is an approach through the meta-learning. From such a standpoint, the focus of the machine learning model is “learn how to learn”. There are different strategies of meta-learning approaches. One of them involves learning candidate initializations of neural networks that are optimal in some sense. Approaches that fall in the latter category are often named Model-Agnostic Meta-Learning (MAML) techniques. One feature common to MAML and other forms of meta-learning strategies is the so-called multi-task learning, which consists of relying on multiple tasks instead of a single one to adjust the model parameters. Multi-task learning, however, requires that these tasks be provided or somehow mined from the available data.

For the custom keyword KWS problem, it has been observed that building these tasks was not straightforward. It has been noticed that different arranges of samples per task result in different performances achieved by the meta-model during testing. Most of the published works in the area of meta-learning simply assume that tasks are already provided in the dataset, or it can be easily inferred from the problem at hand. The search for solutions and criteria to build the required tasks to train a MAML-based model for custom KWS has led to the approach proposed in this disclosure. The present solution can be considered as a heuristic method for creating datasets under the paradigm of multi-task learning. The devised methodology consists in modelling the intrinsic difficulty of each task by considering the probability distribution of the distances between its samples in the model's input data domain. More specifically, the distance values between features extracted from target keywords (in this case, data instances) and keywords from reference databases are taken as representative of the difficulty to solve the keyword identification problem for a given task. The distance values typically observed in reference datasets are characterized in a nonparametric fashion by kernel density (KDE) modelling of their probability distributions. These KDE-modelled distributions are used as reference, from where tasks are created with a controlled degree of difficulty (i.e., the probability of taking a particular distance value according to the modelled probability). In this sense, state-of-the-art documents and their main differences and similarities to the present application will be presented in the following paragraphs.

The paper entitled: “Robust MAML: Prioritization Task Buffer with Adaptive Learning Process for Model-Agnostic Meta-Learning”, IEEE International Conference on Acoustics, Speech and Signal Processing (ICASSP). IEEE, published in 2021, by Nguyen, T. et al, proposes a method for gradually adjusting the distributions of training tasks based on testing tasks during the training of a meta-learner. The goal of that method is to approximate the distribution of training and testing tasks and, as a consequence, improve the generalization of the output meta-model. The points in common between the present invention and this paper is that both methods aim at mitigating the meta-overfitting (i.e., improve the generalization) of a meta-learner by adjusting the distribution of tasks presented during its training. The present invention differentiates from this paper because the latter adjusts the distribution of tasks by actively arranging those tasks during the training of the meta-learner, while the former achieves the same goal by adjusting the samples distribution within each of those tasks to a reference distribution (hence, equalizing the distribution of all tasks available for training and testing) before even training the meta-learner.

The paper entitled: “Efficiently Identifying Task Groupings for Multi-Task Learning”, in Advances Neural Information Processing Systems, published in 2021, by Finn, C. et al, suggests an approach for selecting which tasks should train together in multi-task learning models. To achieve its goal, that method trains a meta-learner to solve all tasks together and then quantifies the effect to which each task's gradient would affect the other tasks' losses. The points in common between the present invention and this paper is that both methods aim at rearranging a meta-dataset in a way that its tasks benefit the most from training together. The present invention differentiates from this paper because the latter groups tasks by training a meta-learner and estimating how the gradient of each task would affect the loss of the others, while the former, as already mentioned, equalizes the distribution of all tasks available for training and testing by adjusting the samples distribution of each task based on a reference distribution without training a meta-learner.

The patent document CN107491782 entitled: “Semantic space information-utilized little training data-oriented image classification method” by Univ Fudan, published on Dec. 19, 2017, makes use of an Autoencoder algorithm to perform Data Augmentation in order to obtain more effective tasks for the few-shot learning problem. The points in common between the present invention and this patent is that they both make use of methods to improve few-shot learning by better constructing training tasks, while the present invention differentiates from this patent because the latter uses a Deep Learning model (i.e., an Autoencoder) to learn a better feature representation and then construct a training dataset better suited for a particular few-shot classification problem. The former, however, uses nonparametric statistics methods to build tasks without the necessity of training any deep learning model.

The paper entitled: “Meta-dataset: A Dataset Of Datasets For Learning To Learn From Few Examples”, ICLR International Conference on Learning Representations, published in 2020, by Triantafillou, E. et al, presents a benchmark dataset for training and testing few-shot learning classifiers. The dataset consists of images from 10 other datasets, including ImageNet and Omniglot. The sampling of the tasks is described in the text and varies according to the task's class set. The points in common between the present invention and this paper are that both focus on the data required to solve few-shot classification problems and propose a method for organizing the data samples to improve the training process. The present invention differentiates from this paper because the task creation in the latter is based on the class structure of the source datasets and introduces a class imbalance, thus resulting in tasks of different levels of difficulty, while in the former, the tasks are created based on a reference distribution that levels the difficulty across tasks.

The patent document CN111328400 entitled: “Meta-learning for multi-task learning for neural networks”, by Magic Leap, published on Jun. 6, 2020, presents strategies training meta-learning models based on selecting a suitable order for the meta-tasks to be presented to the model. The trajectory of the loss functions is used to this end. The points in common between the present invention and this patent are that both attempt to improve the meta-training performance by adjusting the training data and that this data is organized in meta-tasks. The present invention differentiates from this patent because the order of the meta-tasks is selected in the latter assuming that each individual meta-task is already given. On the other hand, the present invention indicates a method for creating the individual meta-tasks in a suitable way.

The thesis entitled: “Few-Shot Learning Neural Network for Audio-Visual Speech Enhancement”, by Maya Rapaport, published in May 2021, proposes a solution for an audio-visual speech enhancement problem. To overcome the challenge of speaker dependency, the problem is approached using few-shot learning methods. The points in common between the present invention and this thesis are that both use a meta-learning approach to solve the problem and both describe how the meta-dataset is generated. The present invention differentiates from this thesis because the thesis randomly draws classes and labels from a uniform distribution to compose the tasks, while the present invention uses a reference distance distribution to guide the tasks' samples selection.

### SUMMARY

A method to generate tasks for meta-learning comprising: representing each point from a set of n labeled samples S and a reference dataset of labeled points R in a feature domain as: R={r¹, r², . . . , r^{α}} and S={s¹, s², . . . , sⁿ}; estimating a probability density function (PDF) of a distance distribution of samples from R, which have a same label k^{x}, to a centroid in the feature domain, respectively, where 1≤x≤1. According to an embodiment, while there are a number of samples available in S, the method further comprises: grouping the samples in S based on a label kx in x groups G, respectively, where G={G1, G2, . . . , Gx}; from each group G, drawing β samples from S as per the PDF estimated from R; and
grouping all 1*β samples into a new task T, wherein β is a user-defined parameter representing a number of samples per label that compose an output task.

### BRIEF DESCRIPTION OF THE DRAWINGS

The objectives and advantages of the current invention will become clearer through the following detailed description of the example and non-limitative drawings presented at the end of this document.

FIG. 1 relates to an operation of extracting features of labeled samples from a reference set R and from a set of n labeled samples S according to an embodiment.

FIG. 2 describes an operation of estimating the probability density function of the distance distribution according to an embodiment.

FIG. 3 presents an operation of grouping the samples in S, drawing β samples following the PDF estimated from R and grouping those 1*β into a new task T according to an embodiment.

FIG. 4 relates to an exemplary embodiment of the method for creating custom keyword-spotting tasks.

### DETAILED DESCRIPTION

Designing an automatic speech recognition framework for Custom Wake-Up requires researching state-of-the-art machine learning solutions that could work in challenging settings. More precisely, the developed solution should be deployed to edge devices, should require very little data for model training, and the inference task should run in a stand-alone, online fashion with no perceptible delay.

Given an input set of example data, the ultimate goal of machine learning is to induce a hypothesis which generalizes to new examples not seen before. In order to achieve such generalization, machine learning methods assume that all data examples, either those used to induce a hypothesis (i.e., train a machine learning model) as well as those only seen after such hypothesis has been formulated (i.e., testing a machine learning model), come from similar distributions. That same principle holds for meta-learning, where each data corresponds to an independent task and the meta-learner aims at inducing a hypothesis on some input tasks which generalizes to new tasks.

Meta-learning methods assume all tasks are drawn from similar distributions. In case that assumption does not hold, there is no guarantee the hypothesis induced by the meta-learner can be generalized to new tasks. That scenario is known as meta-overfitting, since the hypothesis induced by the meta-learner can only explain the data used to formulate that exactly same hypothesis. Hence, the higher the meta-overfitting of a meta-learner the lower tends to be its generalization for new tasks.

Based on the previous premise, drawing training tasks from the same task distribution expected to be observed during testing becomes essential to induce models with high generalization and that can successfully solve new tasks in real-life. Unfortunately, most works in the field of meta-learning assume tasks are already provided, or can be easily inferred from the problem at hand. Hence, the problem of creating a set of tasks that mitigates the meta-overfitting of a meta-learner by drawing those tasks from the same distribution expected in a real-life application is still open.

In summary, the present invention aims to standardize the training and testing tasks of a given meta-dataset in terms of the distance distribution of their respective samples in the feature domain. This is accomplished by randomly choosing which data will be included in each task, guided by the same distance distribution modeled from a similar task extracted from a dataset used as an external reference. For modelling this reference distribution, any statistical method can be considered (e.g., KDE), this invention does not make any assumption on it. Because the distance distributions of the samples of each task follow the same reference, the present invention outputs a meta-dataset that mitigates the distribution shifting between training and testing tasks; hence it benefits the training process of a meta-learner, in a manner analogous to a regular machine learning setting.

Note this invention does not guarantee the best task formulation will be achieved, since it is based on several assumptions that are essentially non-optimal (e.g., the choices of feature representation, distance metric and reference dataset). Nonetheless, no method in the prior art guarantees an optimal solution.

The problem to be solved by the present invention can be more formally described as: given a set S={s¹, s², . . . , sⁿ} of n labeled samples, such that S can be split into m subsets {T¹, T², . . . , T^{m}}, where each subset corresponds to a self-contained classification task T, in order to maximize the learning generalization of a meta-learner trained on {T¹, T², . . . , T^{m}}.

To solve the problem of meta-overfitting when creating a dataset for meta-learning, the proposed method assumes the following definitions:

A meta-set M is a set of m tasks {T¹, T², . . . , T^{m}}.

Each task T corresponds to a set of n labeled points {p¹, p², . . . , pⁿ}.

Each point pₖ^{x} is associated with a label k^{x}∈{k¹, k², . . . , k¹}, 1≤x≤1.

Each task T can be split into two non-overlapping subsets: a training set and a testing set.

Each task T represents a self-contained classification problem where the goal is to predict the correct label of all points from the testing subset given those from the training subset.

M can also be split into two non-overlapping subsets, one for training and another for testing.

Given a set S={s¹, s², . . . , sⁿ} of n input labeled points, the proposed method should output a meta-dataset M that maximizes the meta-generalization of a learning agent trained with its training subset and tested with its testing subset.

A reference dataset of labeled points R={r¹, r², . . . , r^{α}} is available and contains samples from a domain similar to the samples from S.

The proposed method also assumes the following hypotheses:

The difficulty of a task T is related to the distance distribution of the points with same label k^{x} to the centroid of all samples with label k^{x} in the meta-learner's input feature space, ∀×∈[1, 1];

The natural distance distribution of samples within any task can be modeled via nonparametric statistics from an expressive supervised-learning dataset related to that same task.

Assuming a task T with data-points of only 2 arbitrary labels, INV and OOV, the previous hypotheses are motivated by the following intuition: the further the INV samples in a task T are from each other in the feature domain, the highest the chance of the OOV samples from T to get closer to the INV feature centroid. Hence, the INV distances indicate the difficulty of solving T. Since the generalization of a meta-learner can be defined as its capacity to reproduce its same training performance on its test set, it becomes critical to equalize the difficulty-level of the training and test tasks from M.

At the same time, the difficulty level of task T to train a meta-learner can be defined by mimicking the difficulty level of similar tasks expected to be presented to that learner in real-life use cases (i.e., production scenario). Similar tasks could be approximated, for instance, by consolidated datasets designed for traditional self-supervised learning problems. Therefore, by modeling the distribution of the distances of the INV and OOV samples from those datasets in the feature domain and creating task T by imposing that same distance distribution, task T tends to have the same difficulty level as the datasets used as a reference.

That exact same principle can be extended to tasks with points of 1 labels, each task describing a general classification problem. The tasks should compose a meta-learning dataset, which requires an inter-task data diversity, thus each task may contain points from a different set of 1 classes sampled from S. However, the variety of data should not result in a significant variation in the level of difficulty, as our method intends to assure.

Given the previous definitions and hypotheses, the proposed method works by imposing on each task T from meta-dataset M={T¹, T², . . . , T^{m}} a distribution from a reference dataset R={r¹, r², . . . , r^{α}} when sampling points from S={s¹, s², . . . , sⁿ}.

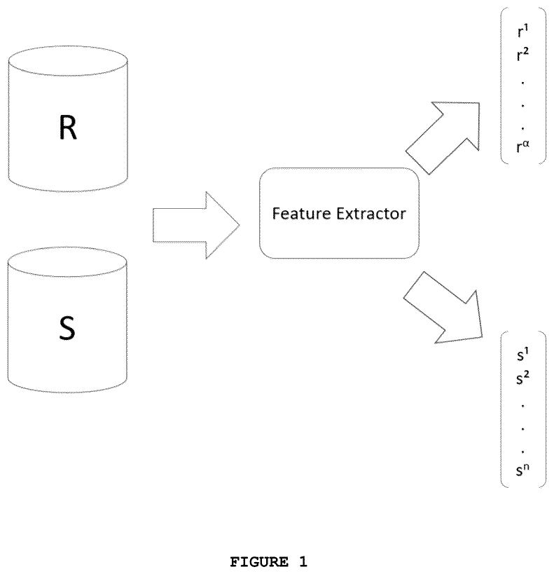

FIG. 1 describes the representation of each point from S and R in the feature domain as: R={r¹, r², . . . , r^{α}} and S={s¹, s², . . . , sⁿ}.

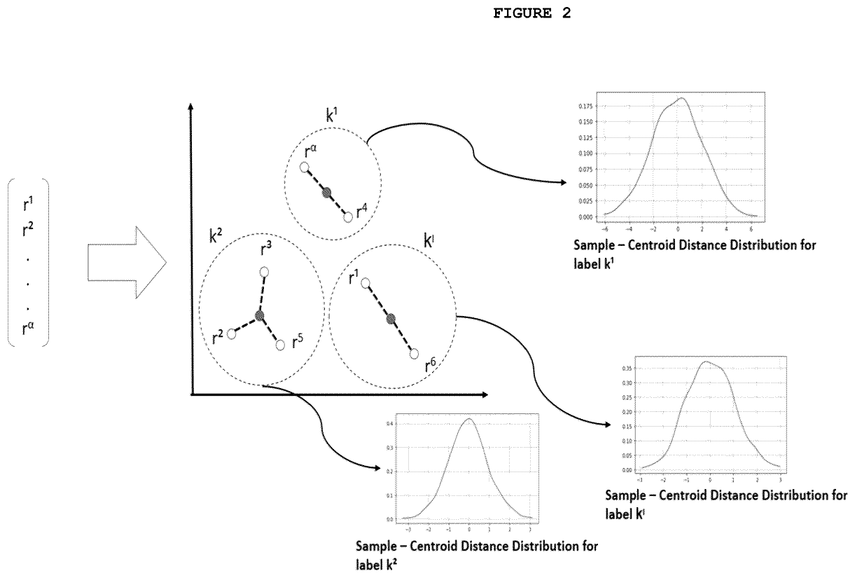

FIG. 2 presents the procedure of estimating the probability density function of (PDF) the distance distribution of some samples from R, which have the same label k^{x}, to their centroid in the feature domain, where 1≤x≤l.

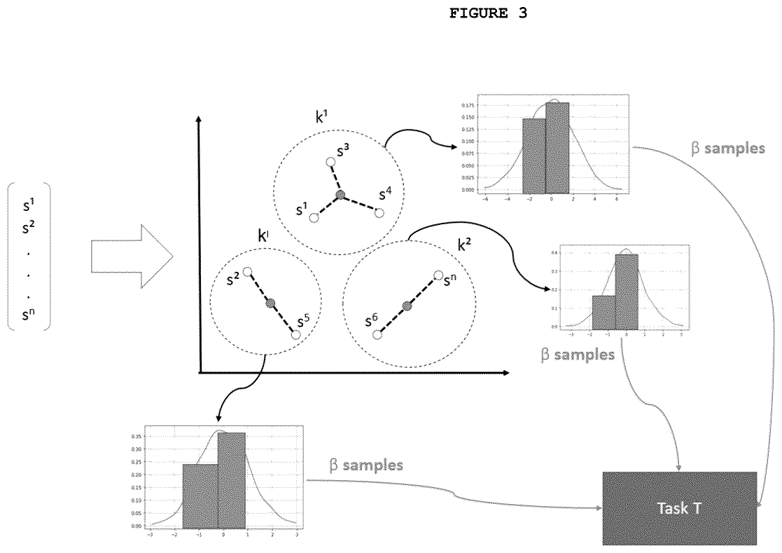

FIG. 3 describes the following operation (s) of the method, wherein while there are enough samples available in S: Group the samples in S based on their label k^{x} in x groups G, where G={G¹, G², . . . , G^{x}};
From each group G, draw β samples from S following the same PDF estimated from R;
Group all 1*β samples into a new task T;
wherein β is a user-defined parameter and represents the number of samples per label that should compose an output task.

In summary, the method to generate tasks for meta-learning comprises the operation (s) of:
representing each point from a set of n labeled samples S and a reference dataset of labeled points R in the feature domain as: R={r¹, r², . . . , r^{α}} and S={s¹, s², . . . , sⁿ};
estimating the probability density function (PDF) of a distance distribution of samples from R, which have a same label k^{x}, to their centroid in the feature domain, where 1≤x≤1;
wherein while there are enough samples available in S the method further comprises:
grouping the samples in S based on their label kx in x groups G, where G={G1, G2, . . . , Gx};
from each group G, drawing β samples from S as per the PDF estimated from R; and
grouping all those 1*β samples into a new task T.

In an exemplary embodiment, the present invention can be applied to the creation of keyword spotting tasks. More precisely, binary classification tasks where the goal is to classify the content of an input audio segment as a target spoken keyword (i.e., INV—inside the vocabulary) or as a non-target keyword (i.e., OOV—out of vocabulary). Usually, the INV samples for each task are chosen based on the available audio segments, so each keyword is considered as the INV sample of at least one task. The real challenge is to select the most suitable OOV samples per task, given its INV samples.

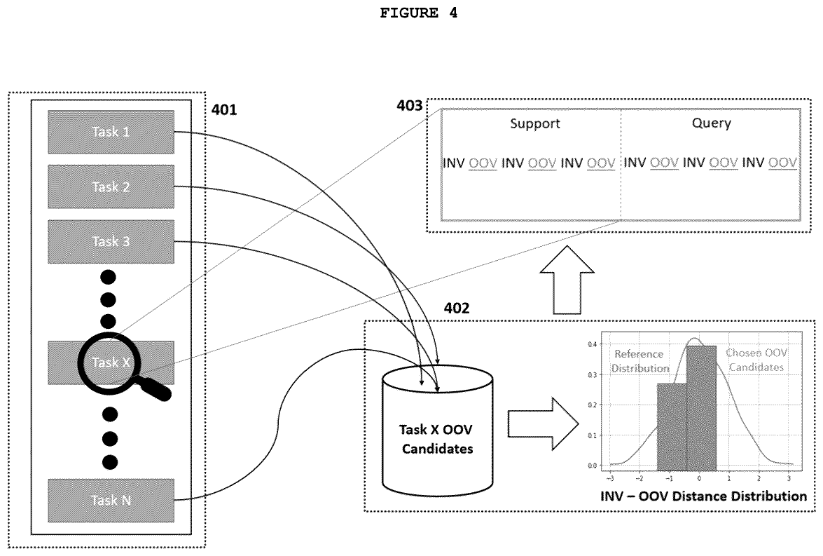

FIG. 4 illustrates how the proposed method can be applied to solve that problem, comprising the following operation (s):
401: Corresponding each task to a keyword-spotting (KWS) problem to solve, each one having a positive class commonly called “Inside Vocabulary” (INV) and a negative class commonly called “Outside of Vocabulary” (OOV). Each task has two partitions, a “support” and a “query” set. These terms are part of the few-shot learning nomenclature, which are analogous to “training” and “testing”, respectively, in a traditional machine learning problem;
402: Assembling INVs from all the other tasks (assuming all the INVs from the other tasks correspond to keywords different from the one in task T) in order to choose the best OOVs for a task T. After that, choosing the most suitable OOV candidates for task T based on a previously known INV-OOV distance distribution (a “Reference Distribution”) of a consolidated KWS dataset (e.g., Google Speech Commands). This process occurs by modeling via nonparametric statistics the probability density function (PDF) of the reference distribution, which is then used to select the OOV examples;
403: Including the chosen OOVs in task T.

In other words, when the method is applied for the creation of keyword-spotting tasks, it further comprises: corresponding each task T to a keyword-spotting (KWS) problem, each task T having a positive class called target keyword (INV) and a negative class called non-target keyword (OOV); representing each point from a set of n labeled samples S and a reference dataset of labeled points R in the feature domain as: R={r¹, r², . . . , r^{α}} and S={s¹, s², . . . , sⁿ}; estimating the probability density function (PDF) of a distance distribution of samples from R, which do not have the label k^{x}, to the centroid of all samples from R with label k^{x} in the feature domain, where 1≤x≤1;
wherein while there are enough samples available in S the method further comprises:
grouping the samples in S based on their label k^{x} in x groups G, where G={G1, G2, . . . , Gx};
choosing ky, 1≤y≤1, to be the INV label and draw β samples from Gy as the INV samples for the output task;
computing, from all groups G, where G≠Gy, the distance between each of their samples and the centroid of Gy;
drawing β samples from all groups G, where G≠Gy, as per the PDF estimated from R; and
grouping all those 2*β samples into a new task.

To demonstrate the efficacy of the proposed method when applied to generate keyword spotting tasks, the following experiment has been performed:

Operation 401 has been executed with the Spanish partition of the free dataset Mozilla Common Voice; each output task containing only INV samples that correspond to a 32×40 spectrogram of the audio clips taken from that dataset.

Next, operations 402 and 403 have been performed twice: once considering the PDF modelled from Google Speech Commands via a kernel-density estimator (KDE), and once considering the PDF of a uniform distribution. Hence, the former output tasks (named “KDE tasks”) correspond to the output of the proposed method, while the latter (named “random tasks” has been used as its baseline. Both datasets contain 39,958 tasks each.

Both datasets have been used to train the meta-learner from the Model-Agnostic Meta-Learning (MAML) scheme through 15K iterations. A small subset of size 64 has been used as a hold-out testing dataset for each “KDE tasks” and “random tasks”. This subset has not been used during training so that the generalization of the resulting models could be properly evaluated.

After training MAML for both datasets, the resulting models have been tested. The following table presents the training and testing losses obtained:

| | | | Ratio between the |
|---|---|---|---|
| | | | final testing and |
| | | | training losses |
| | Final | Final | (the lower the |
| Model | training loss | testing loss | better) |
| “Random | 8.06 | 27.23 | 3.37 |
| tasks” | | | |
| “KDE | 8.06 | 18.23 | 2.26 |
| tasks” | | | |

The results presented in the previous table demonstrate the efficacy of the proposed method to generate tasks for meta-learning that benefits the generalization of a meta-learning, given that it uniforms the distributions of each task.

Although the present invention has been described in connection with certain preferred embodiments, it should be understood that it is not intended to limit the disclosure to those particular embodiments. Rather, it is intended to cover all alternatives, modifications and equivalents possible within the spirit and scope of the disclosure as defined by the appended claims.

What is claimed is:

1. A method to generate tasks for meta-learning comprising:
representing each point from a set of n labeled samples S and a reference dataset of labeled points R in a feature domain as: R={r¹, r², . . . , r^{α}} and S={s¹, s², . . . , sⁿ};
estimating a probability density function (PDF) of a distance distribution of samples from R, which have a same label k^{x}, to a centroid in the feature domain, respectively, where 1≤x≤1;
wherein, while there are a number of samples available in S, the method further comprises:
grouping the samples in S based on a label k^{x} in x groups G, respectively, where G={G1, G2, . . . , Gx};
from each group G, drawing β samples from S as per the PDF estimated from R; and
grouping all 1*β samples into a new task T, wherein β is a user-defined parameter representing a number of samples per label that compose an output task.

2. The method as in claim 1, wherein each task T corresponds to a set of n labeled points {p¹, p², . . . , pⁿ} and each point pₖ^{x} is associated with a label k^{x} ∈ {k¹, k², . . . , k¹}, where 1≤x≤1.

3. The method as in claim 1, wherein a difficulty of a task T is related to the distance distribution of points with same label k^{x} to a centroid of all samples with label k^{x}, ∀×∈[1, 1].

4. The method as in claim 1, wherein the method is applied to binary classification tasks so as to allow classification of content of an input audio segment as a target spoken keyword (INV) or as a non-target keyword (OOV).

5. The method as in claim 4, wherein when applied for creation of keyword-spotting tasks, the method further comprises:
corresponding each task T to a keyword-spotting (KWS) problem, each task T having a positive class called target spoken keyword (INV) and a negative class called non-target keyword (OOV);
representing each data-point from the set of n labeled samples S and the reference dataset of labeled points R in the feature domain as: R={r¹, r², . . . , r^{α}} and S={s¹, s², . . . , sⁿ};
estimating a probability density function (PDF) of a distance distribution of samples from R, which do not have the label k^{x}, to a centroid of all samples from R with label k^{x} in the feature domain, respectively, where 1≤x≤1;
wherein while there are the number of samples available in S the method further comprises:
grouping the samples in S based on a label k^{x} in x groups G, respectively, where G={G1, G2, . . . , Gx};
choosing ky, 1≤y≤1, to be the INV label and draw β samples from Gy as the INV samples for the output task;
computing, from all groups G, where G≠Gy, a distance between each of the samples and the centroid of Gy;
drawing β samples from all groups G, where G≠Gy, as per the PDF estimated from R; and
grouping all 2*β samples into a new task.

6. The method as in claim 4, wherein all INV from other tasks correspond to keywords that are different from the tasks in task T.

7. The method as in claim 4, wherein a target spoken keyword (INV) represents keywords inside a vocabulary.

8. The method as in claim 4, wherein a non-target keyword (OOV) represents keywords out of a vocabulary.

9. The method as in claim 5, wherein the INV samples for each task are chosen based on available audio segments.
